(19) United States
(12) Patent Application Publication
(10) Pub. No.: US 2024/0343330 A1
(43) Pub. Date: Oct. 17, 2024

(54) AUXILIARY BUFFERING DEVICE FOR A BICYCLE SADDLE

(71) Applicants: PETER HSU, TAINAN CITY (TW); LYRA HSU, TAINAN CITY (TW); CHRIS KUO, TAINAN CITY (TW)

(72) Inventors: PETER HSU, TAINAN CITY (TW); LYRA HSU, TAINAN CITY (TW); CHRIS KUO, TAINAN CITY (TW)

(21) Appl. No.: 18/301,654

(22) Filed: Apr. 17, 2023

(51) Int. Cl. B62J 1/02

(52) U.S. Cl. CPC B62J 1/02

(57) ABSTRACT

An auxiliary buffering device comprises upper and lower frames assembled with a bicycle saddle. A first elastic unit is disposed between first ends of the upper and lower frames and is compressible and restorable in a vertical direction. A second elastic unit is disposed between second ends of the upper and lower frames, is compressible and restorable in a horizontal direction, and includes first and second transverse springs. Each of the upper and lower frames includes first and second lateral rods. Two ends of the first transverse spring extend from an end of the first lateral rod of the upper frame and an end of the first lateral rod of the lower frame, respectively. Two ends of the second transverse spring extend from an end of the second lateral rod of the upper frame and an end of the second lateral rod of the lower frame, respectively.

### BACKGROUND OF THE INVENTION

The present invention relates to a bicycle equipment and, more particularly, to an auxiliary buffering device for a bicycle saddle.

Aside from serving as a conventional traffic tool, nowadays bicycle can be used in competition and leisure activities. Since a bicycle is generally pedaled manually, the body weight of the cyclist generally imparts pressure to the bicycle via the buttock. Although the saddle can withstand and buffer the pressure, some bicycles are simplified in volume or weight to reduce the labor burden, including using a relatively smaller, light-weight saddle. However, a relatively large pressure is imparted to the buttock of the cyclist, causing pain and discomfort to the buttock, which is more severe in long-distance travel or sports. Although bicycle equipment and tools can provide various suitable saddles for replacement, current saddles are still acceptable, though not satisfactory, for cyclists having occasional or temporary needs in travel, such that the cyclist may not have the willing to replace the saddle.

The applicants/inventors have filed Taiwan patent application No. 109146686 entitled “SHOCK ABSORBING DEVICE” on Dec. 29, 2020, which has been issued as Invention U.S. Pat. No. 1,755,224. The shock absorbing device is suitable for a saddle and a seat post of a bicycle. The saddle extends in a length direction. The shock absorbing device includes a bottom frame unit, a top frame unit, a front shock absorbing unit, and a rear shock absorbing unit. The bottom frame unit is adapted to be mounted on a top side of the seat post. The top frame unit is disposed above and spaced from the bottom frame unit and is adapted for supporting the saddle thereon. The front shock absorbing unit is connected to a front side of the bottom frame unit and a front side of the top frame unit. The rear shock absorbing unit is pivotably connected between a rear side of the bottom frame unit and a rear side of the top frame unit. With the simplified structural design of the front shock absorbing unit cooperating with the rear shock absorbing unit, the saddle is provided with a 360-degree universal shock absorbing effect on a vertical plane extending in the front-rear direction, thereby providing the cyclist with cycling stability.

Due to the motive of continuing search and development, a need exists for a novel shock absorbing unit with improved buffering function and durability.

### BRIEF SUMMARY OF THE INVENTION

An objective of the present invention is to provide an auxiliary buffering device for a bicycle saddle. The auxiliary buffering device comprises an upper frame and a lower frame. Each of the upper frame and the lower frame is configured to be assembled with the bicycle saddle and includes a first end and a second end. A first elastic unit is disposed between the first ends of the upper and lower frames and is compressible and restorable in a vertical direction. A second elastic unit is disposed between the second ends of the upper and lower frames and is compressible and restorable in a horizontal direction. Each of the upper frame and the lower frame includes first and second lateral rods which are parallel to each other. The second elastic unit includes a first transverse spring and a second transverse spring. An end of the first transverse spring extends from an end of the first lateral rod of the upper frame. Another end of the first transverse spring extends from an end of the first lateral rod of the lower frame. An end of the second transverse spring extends from an end of the second lateral rod of the upper frame. Another end of the second transverse spring extends from an end of the second lateral rod of the lower frame. A coil portion between the end and the another end of the first transverse spring and a coil portion between the end and the another end of the second transverse spring are arranged and spaced from each other in a longitudinal direction. Thus, the first and second transverse spring whose coil portions are arranged in series can provide an overlapping effect in a limited space to increase the buffering effect of the springs. Furthermore, the serially arranged coil portions of the first and second transverse springs are spaced from each other in the longitudinal direction to reduce damage resulting from interaction, prolonging the service life.

When installing the auxiliary buffering device according to the present invention on a bicycle, the bicycle saddle of the bicycle may or may not be replaced while increasing the buffering effect of the bicycle saddle. Furthermore, when not in use, the auxiliary buffering device according to the present invention can be detached to restore the original condition of the bicycle. Aside from the first elastic unit which is compressible and restorable in the vertical direction, multi-orientation buffering and shock-absorbing effect can be provided through the second elastic unit compressible and restorable in the horizontal direction.

In an example, a first buffering unit is disposed on an upper side of the lower frame via at least one supporting sleeve. The rigidity of the first buffering unit is lower than the rigidity of the at least one supporting sleeve.

In an example, a second buffering unit is disposed on the upper side of the lower frame via a support and is spaced from the first buffering unit in the longitudinal direction. The rigidity of the second buffering unit is lower than the rigidity of the support.

In an example, the at least one supporting sleeve includes two supporting sleeves securely and respectively disposed on the first and second lateral rods of the lower frame. The first buffering unit includes two columns respectively disposed on the two supporting sleeves. Each of the two columns extends in the vertical direction and has a tapering top end.

In an example, the support is disposed across the first and second lateral rods of the lower frame, and the second buffering unit is disposed on a top side of the support and is in the form of a column having an arcuate top portion.

The present invention will become clearer in light of the following detailed

description of illustrative embodiments of this invention described in connection with the drawings.

### DESCRIPTION OF THE DRAWINGS

FIG. 1 is a perspective view of an auxiliary buffering device for a bicycle saddle of an embodiment according to the present invention.

FIG. 2 is another perspective view of the auxiliary buffering device for a bicycle saddle of the embodiment according to the present invention.

FIG. 3 is a top view of the auxiliary buffering device for a bicycle saddle of the embodiment according to the present invention.

FIG. 4 is a schematic view illustrating use of the auxiliary buffering device for a bicycle saddle of the embodiment according to the present invention.

### DETAILED DESCRIPTION OF THE INVENTION

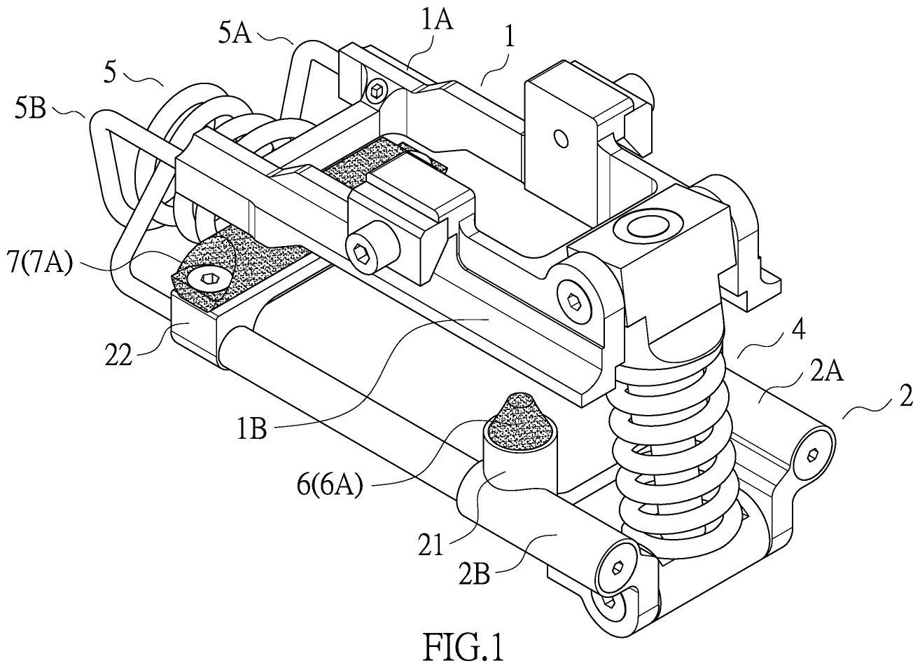

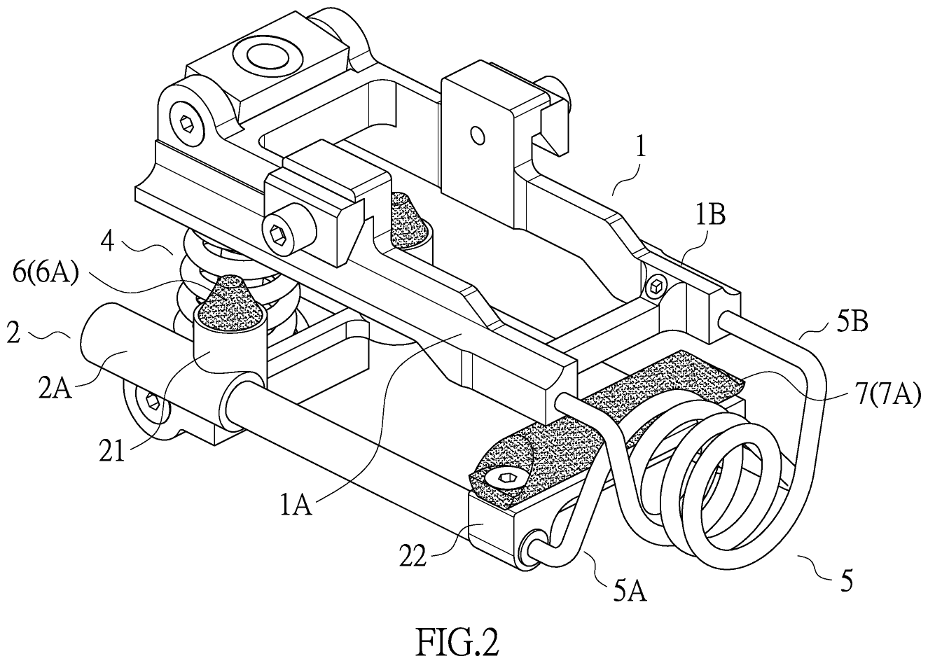

With reference to FIGS. 1-2 showing different perspective views, an auxiliary buffering device for a bicycle saddle 3 of an embodiment according to the present invention comprises an upper frame 1 and a lower frame 2. Each of the upper frame 1 and the lower frame 2 is configured to be assembled with the bicycle saddle 3 and includes a first end and a second end. A first elastic unit 4 is disposed between the first ends of the upper and lower frames 1, 2 and is compressible and restorable in a vertical direction. A second elastic unit 5 is disposed between the second ends of the upper and lower frames 1, 2 and is compressible and restorable in a horizontal direction.

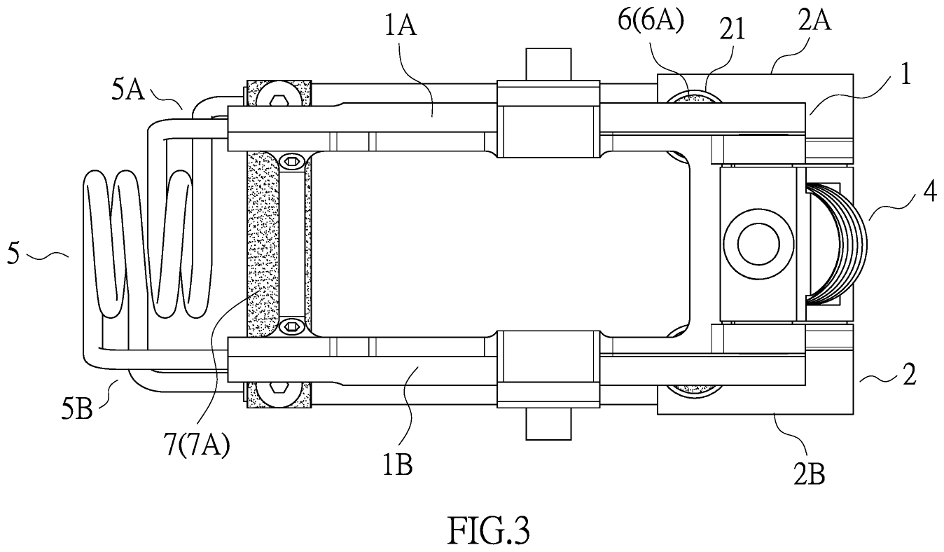

With reference to FIGS. 1 and 2 and further to FIG. 3, each of the upper frame 1 and the lower frame 2 includes first and second lateral rods 1A and 1B, 2A and 2B which are parallel to each other. The second elastic unit 5 includes a first transverse spring 5A and a second transverse spring 5B. An end of the first transverse spring 5A extends from an end of the first lateral rod 1A of the upper frame 1. Another end of the first transverse spring 5A extends from an end of the first lateral rod 2A of the lower frame 2. An end of the second transverse spring 5B extends from an end of the second lateral rod 1B of the upper frame 1. Another end of the second transverse spring 5B extends from an end of the second lateral rod 2B of the lower frame 2. A coil portion between the end and the another end of the first transverse spring 5A and a coil portion between the end and the another end of the second transverse spring 5B are arranged and spaced from each other in a longitudinal direction. Thus, the first and second transverse spring 5A and 5B whose coil portions are arranged in series can provide an overlapping effect in a limited space to increase the buffering effect of the springs. Furthermore, the serially arranged coil portions of the first and second transverse springs 5A and 5B are spaced from each other in the longitudinal direction to reduce damage resulting from interaction, prolonging the service life.

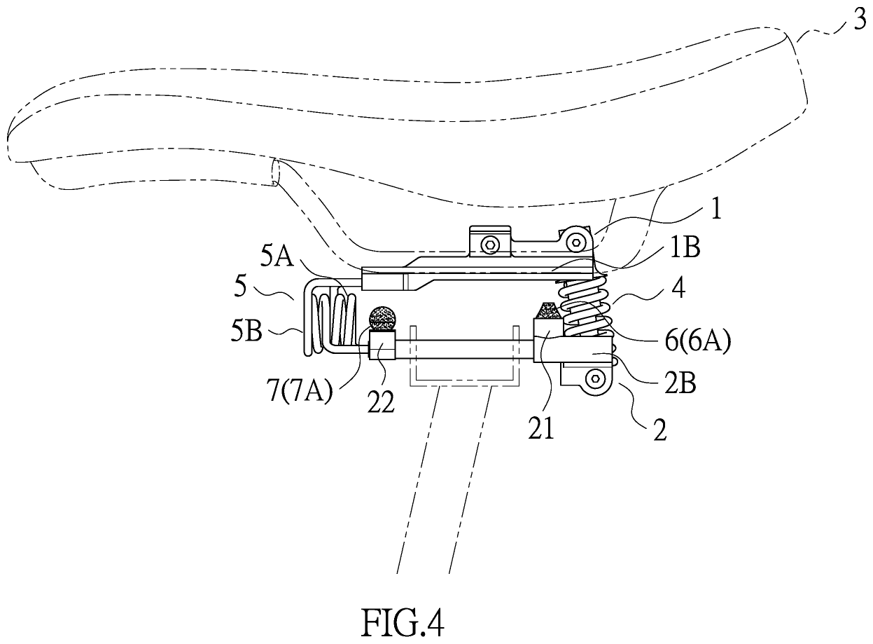

With reference to FIG. 4, when installing the auxiliary buffering device according to the present invention on a bicycle, the bicycle saddle 3 of the bicycle may or may not be replaced while increasing the buffering effect of the bicycle saddle 3. Furthermore, when not in use, the auxiliary buffering device according to the present invention can be detached to restore the original condition of the bicycle. Aside from the first elastic unit 4 which is compressible and restorable in the vertical direction, multi-orientation buffering and shock-absorbing effect can be provided through the second elastic unit 5 compressible and restorable in the horizontal direction.

In a preferred embodiment of the present invention, a first buffering unit 6 is disposed on an upper side of the lower frame 2 via at least one supporting sleeve 21. The rigidity of the first buffering unit 6 is lower than the rigidity of the at least one supporting sleeve 21. When the springs are compressed to the maximum extents, the first buffering unit 6 with a lower rigidity can be used for further buffering.

Furthermore, in the preferred embodiment of the present invention, a second buffering unit 7 is disposed on the upper side of the lower frame 2 via a support 22 and is spaced from the first buffering unit 6 in the longitudinal direction. The rigidity of the second buffering unit 7 is lower than the rigidity of the support 22. When the springs are compressed to the maximum extents, the second buffering unit 7 with a lower rigidity can be used for further buffering.

With reference to FIGS. 1 and 2, specifically, in the preferred embodiment of the present invention, there are two supporting sleeves 21 securely and respectively disposed on the first and second lateral rods 2A, 2B of the lower frame 2. The first buffering unit 6 includes two columns 6A respectively disposed on the two supporting sleeves 21. Each of the two columns 6A extends in the vertical direction and has a tapering top end. Since the tapering top end of each of the two columns 6A is fragile and less rigid, a “collapse effect” can be provided. When the springs are compressed to the maximum extents under an extremely poor road condition, the first buffering unit 6 which has a lower rigidity and which is fragile can be used for further buffering.

More specifically, the support 22 is disposed across the parallel first and second lateral rods 2A, 2B of the lower frame 2. The second buffering unit 7 is disposed on a top side of the support 22 and is in the form of a column 7A having an arcuate top portion. Since the top portion of the column 7A is arcuate and less rigid, a further buffering effect can be provided when the springs are compressed to the maximum extends.

Although specific embodiments have been illustrated and described, numerous modifications and variations are still possible without departing from the scope of the invention. The scope of the invention is limited by the accompanying claims.

1. An auxiliary buffering device for a bicycle saddle, with the auxiliary buffering device comprising an upper frame and a lower frame, wherein each of the upper frame and the lower frame is configured to be assembled with the bicycle saddle and includes a first end and a second end, wherein a first elastic unit is disposed between the first ends of the upper and lower frames and is compressible and restorable in a vertical direction, wherein a second elastic unit is disposed between the second ends of the upper and lower frames and is compressible and restorable in a horizontal direction,
wherein each of the upper frame and the lower frame includes first and second lateral rods which are parallel to each other, wherein the second elastic unit includes a first transverse spring and a second transverse spring, wherein an end of the first transverse spring extends from an end of the first lateral rod of the upper frame, wherein another end of the first transverse spring extends from an end of the first lateral rod of the lower frame, wherein an end of the second transverse spring extends from an end of the second lateral rod of the upper frame, wherein another end of the second transverse spring extends from an end of the second lateral rod of the lower frame, and wherein a coil portion between the end and the another end of the first transverse spring and a coil portion between the end and the another end of the second transverse spring are arranged and spaced from each other in a longitudinal direction.

2. The auxiliary buffering device for the bicycle saddle as claimed in claim 1, wherein a first buffering unit is disposed on an upper side of the lower frame via at least one supporting sleeve, and wherein a rigidity of the first buffering unit is lower than a rigidity of the at least one supporting sleeve.

3. The auxiliary buffering device for the bicycle saddle as claimed in claim 2, wherein a second buffering unit is disposed on the upper side of the lower frame via a support and is spaced from the first buffering unit in the longitudinal direction, and wherein a rigidity of the second buffering unit is lower than a rigidity of the support.

4. The auxiliary buffering device for the bicycle saddle as claimed in claim 2, wherein the at least one supporting sleeve includes two supporting sleeves securely and respectively disposed on the first and second lateral rods of the lower frame, wherein the first buffering unit includes two columns respectively disposed on the two supporting sleeves, and wherein each of the two columns extends in the vertical direction and has a tapering top end.

5. The auxiliary buffering device for the bicycle saddle as claimed in claim 3, wherein the support is disposed across the first and second lateral rods of the lower frame, wherein the second buffering unit is disposed on a top side of the support and is in a form of a column having an arcuate top portion.
